(19) United States
(12) Patent Application Publication
(10) Pub. No.: US 2024/0387814 A1
(43) Pub. Date: Nov. 21, 2024

(54) CATHODE PASTE, METHOD FOR PRODUCING SAME, AND USE THEREOF

(71) Applicant: VARTA Microbattery GmbH, Ellwangen Jagst (DE)

(72) Inventor: Sebastian SCHEBESTA, Ellwangen (DE)

(21) Appl. No.: 18/570,108

(22) PCT Filed: Jul. 19, 2022
(86) PCT No.: PCT/EP2022/070261

§ 371 Date: Dec. 14, 2023

(30) Foreign Application Priority Data
Aug. 4, 2021 (EP) 21189700.4
Aug. 9, 2021 (DE) 10 2021 120 625.1

(51) Int. Cl. H01M 4/525; H01M 4/02; H01M 4/04; H01M 4/1391; H01M 4/62; H01M 10/0525; H01M 10/058

(52) U.S. Cl. CPC H01M 4/525; H01M 4/0404; H01M 4/1391; H01M 4/623; H01M 10/0525; H01M 10/058; H01M 2004/028

(57) ABSTRACT

In a cathode paste (1) for producing a cathode of a lithium-ion cell, the cathode paste comprises, as an active material, a metallic lithium mixed oxide selected from the group consisting of a lithium-nickel-manganese-cobalt mixed oxide represented by the formula LiNiₓMn_{y}Co_{z}O₂, wherein x+y+z=1 and x≥0.6, and a lithium-nickel-cobalt-aluminum mixed oxide of the formula LiNiₓCo_{y}Al_{z}O₂, wherein x+y+z=1 and x≥0.8, and mixtures with said lithium mixed oxides. Further, the cathode paste comprises a polyvinylidene difluoride-based electrode binder. Further, the cathode paste comprises a solvent comprising N-methylpyrrolidone and/or N-ethylpyrrolidone. Furthermore, the solvent comprises an organic additive component suitable for neutralizing hydroxide ions and having a boiling point at atmospheric pressure in the range from 50° C. to 210° C.

### CROSS REFERENCE TO RELATED APPLICATIONS

This application is a U.S. National Phase application under 35 U.S.C. § 371 of International Application No. PCT/EP2022/070261, filed on Jul. 19, 2022, and claims benefit to European Patent Application EP 21189700.4, filed on Aug. 4, 2021, and to German Patent Application No. DE 10 2021 120 625.1, filed on Aug. 9, 2021. The International Application was published in German on Feb. 9, 2023 as WO 2023/011914 under PCT Article 21 (2).

### FIELD

The present disclosure relates to a cathode paste, a method of producing the same, a use of the cathode paste, and a method of producing an electrochemical energy storage cell using the cathode paste.

### BACKGROUND

Lithium-ion cells are a widely used type of energy storage element. In general, an energy storage element is understood to be both a single electrochemical cell capable of storing electrical energy and a battery with several electrically interconnected electrochemical cells capable of storing electrical energy. Each electrochemical cell comprises at least one positive and at least one negative electrode, which are generally separated from each other by a separator.

In electrochemical cells, an electrochemical, energy-supplying reaction takes place which is composed of two electrically coupled but spatially separated partial reactions. One partial reaction, which takes place at a comparatively lower redox potential, occurs at the negative electrode, and one at a comparatively higher redox potential occurs at the positive electrode. During discharge, electrons are released at the negative electrode as a result of an oxidation process, resulting in an electron flow via an external consumer to the positive electrode, from which a corresponding quantity of electrons is taken up. A reduction process thus takes place at the positive electrode. At the same time, for the purpose of charge equalization, an ion current corresponding to the electrode reaction occurs within the energy storage element. This ion current crosses the separator and is ensured by an ion-conducting electrolyte.

In secondary (rechargeable) electrochemical cells, this discharge reaction is reversible, so it is possible to reverse the conversion of chemical energy into electrical energy that occurred during discharge.

When the terms “anode” and “cathode” are used in connection with secondary electrochemical cells, the electrodes are generally named according to their discharge function. The negative electrode in such energy storage elements is thus the anode, the positive electrode the cathode.

A lithium-ion cell comprises electrodes that can reversibly absorb and release lithium ions and an electrolyte containing lithium ions. The electrodes of lithium-ion cells are usually composed of an electrically conductive current collector as well as electrochemically active components (often referred to as active materials) and, if necessary, electrochemically inactive components. The electrochemically inactive components perform important functions in the electrodes, but are not involved in the storage of lithium or lithium ions.

The current collectors have the function of electrically contacting the electrochemically active components over as large an area as possible. They usually consist of ribbon-shaped metal foils, for example, or a metal foam, or a metal mesh, or a metal grid, or a metallized nonwoven.

All materials capable of absorbing and releasing lithium ions can be used as active materials for the electrodes of secondary lithium-ion cells. Prior art materials for the negative electrode (anode) of secondary lithium-ion cells are in particular carbon-based materials such as graphitic carbon or non-graphitic carbon materials capable of intercalating lithium. Furthermore, metallic and semi-metallic materials that are alloyable with lithium can also be used. For example, the elements tin, antimony, and silicon can form intermetallic phases with lithium. In particular, the carbon-based active materials can also be combined with the metallic and/or semi-metallic materials.

For the positive electrode (cathode) of secondary lithium-ion cells, metallic lithium mixed oxides, which may contain nickel, are used as active materials, among others. Lithium-nickel-manganese-cobalt oxide (NMC) and lithium-nickel-cobalt-aluminum oxide (NCA) are particularly common. Mixtures and derivatives of the above materials can also be used.

Electrochemically inactive components are, first and foremost, electrode binders (bonding agents) and conductive agents. The electrode binders ensure the mechanical stability of the electrodes and provide contact between the particles of electrochemically active material and the current collector. Common electrode binders are often based on polyvinylidene difluoride (PVDF). Conducting agents such as carbon black have the function of elevating the electrical conductivity of the electrodes.

Porous plastic films, for example made from a polyolefin, a polyester or a polyether ketone, are particularly suitable as separators for lithium-ion cells. Nonwovens and fabrics made from these materials can also be used.

As an ion-conducting electrolyte, lithium-ion cells can contain, for example, a mixture of organic carbonates in which a lithium salt is dissolved. A frequently used example of a suitable lithium salt is lithium hexafluorophosphate (LiPF₆). Preferably, the electrodes and separators of lithium-ion cells are impregnated with the electrolyte.

It is known to produce the cathodes of lithium-ion cells or of corresponding batteries using solvent-based cathode pastes which comprise the active material for the cathode, binder and optionally a conductive agent such as carbon black. These cathode pastes are applied to the flat current collector, i.e. in particular to a flat metal substrate such as an aluminum foil, in a thin layer and generally dried.

A very common substance class for the electrode binder or the binder is polyvinylidene difluoride (PVDF). The use of this binder class requires the use of aprotic and strongly polar solvents. The use of N-methylpyrrolidone (NMP) or N-ethylpyrrolidone (NEP) is widespread in this context.

However, the use and processing of such cathode pastes are not without problems. In particular, premature gelation of the cathode paste can occur, making subsequent processing more difficult. In addition, quality fluctuations can occur in the lithium-ion cells produced using the cathode pastes.

The main problem in this context is the high hygroscopicity of the cathode active materials used. These materials, in particular lithium nickel manganese cobalt oxide or lithium nickel cobalt aluminum oxide, react with the surrounding moisture to form strongly alkaline hydroxide compounds. These hydroxide compounds can in turn attack the comparatively acidic hydrogen atoms of the polyvinylidene difluoride and trigger a crosslinking reaction of the electrode binder. This can lead to a change in the viscosity of the cathode paste and to premature gelation. In addition, the adhesion properties of the cathode paste are reduced, so that the cathode paste may become unusable for further use.

Previous approaches to solving this problem work, for example, with a chemical modification of the polyvinylidene difluoride, wherein, for example, a substitution of hydrogen atoms or a co-polymerization with other monomers is carried out. Polyvinylidene difluoride modified in this way generally reacts less rapidly than unmodified polyvinylidene difluoride.

US 2013/0309570 A1 suggests, as another approach, to add an inorganic additive such as alumina, zirconia or vanadium oxide to the paste in order to avoid gelation of the cathode paste.

As another option, U.S. Pat. No. 7,829,219 B2 suggests adding a polymerization inhibitor in the form of a catechol derivative to the cathode paste.

However, these approaches are associated with disadvantages, as they change the components of the resulting cathode. In the first case, this is achieved by a complex modification of the PVDF, and in the other cases by the addition of further components or foreign substances to the cathode paste, which can change the properties of the resulting cathode. For example, this can affect the bonding properties of the cathode paste on the current collector.

Another approach to solving the problem attempts to avoid the problematic introduction of moisture during the production of the cathode as far as possible. This can be done in particular by using appropriate protective gases and highly dry atmospheres during the cathode production process. However, this is a technologically complex and expensive measure during production, which is therefore disadvantageous from the point of view of the lithium-ion cell producers.

### SUMMARY

In an embodiment, the present disclosure provides a cathode paste for producing a cathode of a lithium-ion cell. The cathode paste includes a metallic lithium mixed oxide selected from: a lithium-nickel-manganese-cobalt mixed oxide of the formula LiNixMnyCozO2, wherein x+y+z=1 and x≥0.6, a lithium-nickel-cobalt-aluminum mixed oxide of the formula LiNixCoyAlzO2, wherein x+y+z=1 and x≥0.8, and/or a mixture comprising the lithium-nickel-manganese-cobalt mixed oxide and/or the lithium-nickel-cobalt-aluminum mixed oxide. The cathode paste further includes polyvinylidene difluoride as an electrode binder or an electrode binder comprising polyvinylidene difluoride. In addition, the cathode paste includes a solvent comprising: N-methylpyrrolidone and/or N-ethylpyrrolidone, and an organic additive component capable of neutralizing hydroxide ions and having a boiling point at atmospheric pressure in a range from 50° C. to 210° C.

### BRIEF DESCRIPTION OF THE DRAWINGS

Subject matter of the present disclosure will be described in even greater detail below based on the exemplary FIGURES. All features described and/or illustrated herein can be used alone or combined in different combinations. The features and advantages of various embodiments will become apparent by reading the following detailed description with reference to the attached drawings, which illustrate the following:

FIG. 1 shows an exemplary method for applying a cathode paste to a current collector.

### DETAILED DESCRIPTION

The present disclosure provides an improved cathode paste which avoids the problems mentioned in the prior art. In particular, the cathode paste is intended to avoid quality fluctuations in the resulting lithium-ion cell or in corresponding batteries. Furthermore, problems in the production process that may occur as a result of changes in the state of the cathode paste are to be avoided. In addition, a cathode paste is to be provided which allows a less complex production process for the lithium-ion cells, wherein at the same time the quality and the properties of the lithium-ion cell or corresponding batteries and in particular the properties of the cathode are consistently good.

The present disclosure provides a cathode paste, a method of producing a cathode paste, a use of the cathode paste for producing lithium-ion cells, and a method of producing a lithium-ion cell using the cathode paste.

According to a first aspect, a cathode paste is provided that is suitable for the production of a cathode of a lithium-ion cell or a corresponding battery and is characterized by the following features a. to d.:
a. The cathode paste comprises, as an active material, a metallic lithium mixed oxide selected from the group consisting of a lithium-nickel-manganese-cobalt mixed oxide of the formula LiNiₓMn_{y}Co_{z}O₂, wherein x+y+z=1 and x≥0.6, and a lithium-nickel-cobalt-aluminum mixed oxide of the formula LiNiₓCo_{y}Al_{z}O₂, wherein x+y+z=1 and x≥0.8, and mixtures with said lithium mixed oxides;
b. The cathode paste comprises a polyvinylidene difluoride-based electrode binder;
c. The cathode paste comprises a solvent comprising N-methylpyrrolidone (NMP) and/or N-ethylpyrrolidone (NEP);
d. The solvent comprises an organic additive component capable of neutralizing hydroxide ions and having a boiling point at atmospheric pressure in the range from 50° C. to 210° C., preferably in the range from 100° C. to 210° C.

The metallic lithium mixed oxide is a mixed oxide containing nickel in an atomic proportion of 60% or more. The inventors were able to determine that in particular with such cathode active materials with a nickel content of more than 60%, the described problems with an undesirable cross-linking of the electrode binder occur, which make further processing of the cathode paste in a coating process difficult or impossible.

In preferred embodiments of the cathode paste, lithium mixed oxides with a high nickel content are used, which are commonly used in lithium-ion cell production. For example, NMC-622 and NMC-811 are preferred, wherein the numerical sequence refers respectively to the atomic proportions of nickel, manganese and cobalt in the mixed oxide, i.e. an atomic ratio of 6:2:2 and of 8:1:1, respectively. Another preferred example is NCA-811 with nickel, cobalt and aluminum in a ratio of 8:1:1.

Experiments have shown that by adding the organic additive component to the cathode paste, it is possible to significantly improve the properties of the cathode paste and thus make the mixing process of the cathode paste and the coating process in the production of the cathode simpler and less costly. The organic additive component achieves consistent quality and processability of the cathode paste, so that quality fluctuations in the cathode that can be produced with it are avoided. In particular, the organic additive component in the cathode paste prevents undesirable and premature gelling of the cathode paste, which would make subsequent processing significantly more difficult.

The cathode paste also allows special technical measures to be dispensed with during processing of the cathode paste, which are intended to prevent the effects of moisture and thus avoid undesirable gelation.

Due to the property of the organic additive component with regard to neutralization of hydroxide ions, this additive component ensures that undesirable crosslinking of the PVDF is avoided. Furthermore, the boiling point of the organic additive component, which at atmospheric pressure is preferably in the range from 50° C. to 210° C., preferably in the range from 80° C. to 210° C., preferably in the range from 100° C. to 210° C. or in the range from 80° C. to 150° C., ensures that the organic additive component evaporates practically completely under the drying conditions used during the cathode production process. Thus, there are practically no residues of the organic additive component left in the coated and dried cathode. Thus, the properties of the finished cathode are not affected by the organic additive component in the cathode paste. On the other hand, the organic additive component influences the viscosity properties of the cathode paste during the production of the cathode paste and during its processing in such a way that undesirable crosslinking of the PVDF is avoided. On the one hand, this facilitates processing of the cathode paste. Furthermore, the organic additive component facilitates storage and transport of the finished cathode paste, or even makes this possible in the first place, since the organic additive component prevents premature gelation of the cathode paste.

Overall, the present disclosure permits the production and processing of a cathode paste with, in principle, the commonly used materials, wherein, in particular, lithium mixed oxides with a nickel content of 60% or more and polyvinylidene difluoride (PVDF) can be used as electrode binders using the solvent N-methylpyrrolidone (NMP) and/or N-ethylpyrrolidone (NEP), without the problems mentioned at the outset. In particular, it is not necessary to take additional dehumidification measures in the mixing process of the cathode paste and in the coating process to prevent undesirable crosslinking of the electrode binder. Furthermore, there is no need for polymerization inhibitors or other additives, such as inorganic additives like aluminum oxide, zirconium oxide, vanadium oxide or the like, which would change the composition of the resulting cathode and thus its properties. Furthermore, it is also not necessary to use certain modified PVDF polymers or co-polymerized PVDFs as electrode binders, which are intended to prevent crosslinking. In preferred embodiments, therefore, the cathode paste is free of further inorganic additives and/or polymerization inhibitors and/or free of modified PVDF polymers.

The cathode paste thus dispenses with special binder materials, which would be associated with higher costs. Furthermore, when using the cathode paste, technologically complex solutions in the production of the cathodes, such as in particular drying chambers and protective atmospheres in the mixing and coating area, can be dispensed with. The use of the organic additive component leads to a stabilization of the resulting cathode paste, which results in easier handling of the cathode paste compared with conventional cathode pastes, as well as improved storability and coatability. This increases process reliability and ensures seasonal independence, wherein a consistent quality of the cathode paste and the cathodes that can be produced with it is also achieved, particularly at somewhat higher ambient temperatures. In addition, the cathode paste also offers an economic advantage, since commercially available chemicals can be used and since no complex technological measures are required in the mixing and coating process.

The cathode paste is a non-aqueous electrode paste in which one or more organic solvents are contained.

The NMP and/or NEP used for the production of the cathode paste is preferably of battery grade quality. The solvent is characterized in particular by the fact that it contains as little water as possible. For example, the solvent used may contain a maximum of 300 ppm water, preferably also less.

In an embodiment, the cathode paste is characterized by the following additional feature a:
a. The cathode paste is stable with respect to its viscosity properties at room temperature for a period of at least 2 weeks, preferably at least 4 weeks.

“Room temperature” in this context means a temperature in the range from 20° C. to 25° C. at a relative humidity of 20-50%. “Stability” in this context means that the viscosity (measured fresh at 200/s (plate-plate 40 mm)), which can be determined on the basis of rheological measured values, does not change by more than 20%. For example, the viscosity may increase from 1.3 Pas to 1.5 Pas within the four weeks.

Comparative tests showed that the viscosity properties of the cathode paste disclosed herein remain stable for several weeks even during prolonged storage at room temperature in a closed vessel. During such a longer period, the flowability of the cathode paste does not change significantly. In particular, no detectable gelation of the cathode paste occurs and the material remains homogeneously miscible and flowable. Furthermore, no or hardly any sedimentation of constituents of the paste occurs. It is expedient to keep the cathode paste in a closed container during storage so that evaporation of the solvent components of the cathode paste does not occur.

The stable viscosity properties of the cathode paste over a longer period of time, which may, for example, be more than four weeks, significantly simplify the processability of the cathode paste. In particular, it is possible to produce the cathode paste in stock and to use it only when required. Furthermore, it is thereby possible to produce, store and, if necessary, transport the cathode paste so that the cathode paste can be further processed at another location.

In a preferred manner, the cathode paste is characterized by at least one of the following additional features a. and/or b.:
a. The organic additive component is present in the solvent in a proportion of 0.1 to 10% by weight, preferably in a proportion of 0.5 to 7% by weight, preferably in a proportion of 1 to 5% by weight;
b. The N-methylpyrrolidone and/or the N-ethylpyrrolidone is present in the solvent in a proportion of from 60 to 99.9% by weight, preferably from 80 to 99.5% by weight.

In preferred embodiments, the proportion of the organic additive component in the solvent is adjusted so that the organic additive component is added in a superstoichiometric amount with respect to the electrode binder or the PVDF in the cathode paste. Generally, a proportion of 5% by weight of the organic additive component in the solvent is sufficient. Depending on the mixing ratios in the cathode paste and, in particular, also depending on the proportion of the electrode binder in the cathode paste, smaller amounts may also be sufficient. In preferred embodiments, for example, 5% by weight of organic additive component or 1.2% by weight of organic additive component may be present in the solvent.

In preferred embodiments, the solvent consists of only two components, namely the organic additive component and the actual solvent N-methylpyrrolidone (NMP) and/or N-ethylpyrrolidone (NEP), so that the sum of the proportions of the solvent NMP and/or NEP and the organic additive component is 100%. If necessary, it may also be provided that further components are present in the solvent, for example a further organic solvent, or that, for example, NMP and NEP are present as a mixture. The use of only the solvent NEP may be preferred, since NEP is classified as less toxic than NMP.

In a further preferred embodiment, the cathode paste is characterized by at least one of the following additional features a. to c.:
a. The organic additive component is or comprises an organic acid, in particular acetic acid, preferably anhydrous acetic acid, and/or oxalic acid and/or malonic acid;
b. The organic additive component is or comprises a precursor of an organic acid, in particular an ester of an organic acid, preferably an ester of ortho-carbonic acid and/or formic acid, or an anhydride of an organic acid, preferably acetic anhydride and/or maleic anhydride;
c. The organic additive component is or comprises a C—H-acidic organic compound, in particular an ester and/or a diester and/or a ketone and/or a diketone and/or a nitrile and/or a dinitrile, and/or an organohalogen compound and/or a mixed-substituted compound, in particular methyl acetoacetate, diethyl malonic acid ester, chloroacetic acid ester and/or ethyl acetoacetate.

In particular, the organic additive component is a component that is soluble in NMP and/or NEP or that is readily miscible with NMP and/or NEP.

All the organic additive components preferred according to the above features a. to c. have the property that they can neutralize hydroxide ions and thus reliably prevent crosslinking of the polyvinylidene difluoride in the cathode paste. The chemical processes that take place in this process may vary, but the result is that gelation of the cathode paste is prevented. In particular, this can be caused by reactivity to moisture in the alkaline medium or via reactivity with strongly alkaline compounds to form stable salts, or by reactivity with alkaline compounds or deprotonated PVDF due to strong acidic hydrogen atoms.

Furthermore, it may be preferred that the organic additive component, in particular an organic acid used as the organic additive component, is anhydrous or substantially anhydrous.

The use of ethyl acetoacetate and/or anhydrous acetic acid as an organic additive has proved particularly advantageous in this context.

In embodiments of the cathode paste, the cathode paste is characterized by the following additional feature a:
a. The organic additive component is acetoacetic acid ethyl ester and is present in the solvent in a proportion of 1 to 5% by weight, preferably 5% by weight.

In an alternative, likewise preferred embodiment of the cathode paste, the cathode paste is characterized by the following additional feature a:
a. The organic additive component is anhydrous acetic acid and is present in the solvent in a proportion of 1 to 5% by weight, preferably 1.2% by weight.

Both when acetoacetic acid ethyl ester was used as the organic additive component and when anhydrous acetic acid was used as the organic additive component, the inventors' tests showed that no gelation of the paste occurred even after the cathode paste had been stored for a longer period, in particular after more than 40 days. The material was still homogeneously miscible and flowable, so that it was readily amenable to processing in a coating process.

With respect to the proportion of solvent in the cathode paste as a whole, the cathode paste is characterized in a preferred manner by the following additional feature a:
a. The proportion of solvent in the cathode paste is in the range from 10 to 50% by weight, preferably in the range from 25 to 40% by weight, in particular in the range from 25 to 30% by weight.

In relation to the total composition of the cathode paste, the proportion of the organic additive component can lie in particular in the range from 0.3% to 2%.

The proportion of the solvent and, in particular, the proportion of the organic additive component in the total cathode paste can suitably be adapted to the proportions of the other components. In particular, the proportion of the organic additive component can be adapted to the amount of the respective active material in order to obtain a superstoichiometric ratio.

With respect to the electrode binder, in preferred embodiments the cathode paste is characterized by at least one of the following additional features a. or b.:
a. The polyvinylidene difluoride is a polyvinylidene difluoride homopolymer;
b. The polyvinylidene difluoride comprises ionically crosslinkable components.
c. The polyvinylidene difluoride has an average molecular weight in the range from 200000 g/mol to 1000000 g/mol, preferably in the range from 400000 g/mol to 850000 g/mol.

Preferably, the electrode binder is PVDF. The PVDF can be provided as a powder, for example. A PVDF material that is commonly used for the production of lithium-ion cells is suitable as an electrode binder. Preferably, the PVDF in this case has a high molecular weight, which is common for applications in this region. In particular, a homopolymeric PVDF can be used for typical battery applications.

The total amount of PVDF in the cathode paste is preferably in the range from 0.5 wt % to 20 wt %, more preferably in the range from 1 wt % to 10 wt %. In some preferred embodiments, the amount of PVDF in the total cathode paste may be in particular 1.5 wt %+1 wt %.

It is also preferred that the cathode paste contains a conductive agent, preferably conductive carbon black. The proportion of conductive carbon black in the cathode paste can be within the usual range. For example, the proportion of conductive carbon black or generally of the conductive agent can be in the range from 1 wt. % to 30 wt. %, preferably 5 wt. % to 20 wt. %. In a preferred embodiment of the cathode paste, the proportion of conductive carbon black is 3 wt. %±1 wt. %.

The present disclosure further provides a method of producing a cathode paste, which is characterized in particular by the organic additive component in the manner described above. The method of producing the cathode paste comprises the following method steps a. to g:
a. A solvent is provided which comprises N-methylpyrrolidone and/or N-ethylpyrrolidone as a solvent and an organic additive component capable of neutralizing hydroxide ions and having a boiling point at atmospheric pressure in the range from 50° C. to 210° C.;
b. An electrode binder based on polyvinylidene difluoride is dissolved in the solvent with stirring;
c. Optionally, a conductive agent, in particular conductive carbon black, is added;
d. A metallic lithium mixed oxide selected from the group consisting of a lithium-nickel-manganese-cobalt mixed oxide of the formula LiNiₓMn_{y}Co_{z}O₂, wherein x+y+z=1 and x≥0.6, and a lithium-nickel-cobalt-aluminum mixed oxide of the formula LiNiₓCo_{y}Al_{z}O₂, wherein x+y+z=1 and x≥0.8, and mixtures with said lithium mixed oxides;
e. The lithium mixed oxide according to step d. is mixed with the mixture resulting from step b. or c.;
f. Optionally, to set a specific viscosity, in particular a viscosity in the range from 1.25 Pas-1.8 Pas (preferably measured with a dynamic viscosity measurement plate—plate (40 mm) at 200/s shear rate), a further solvent is added to the mixture resulting from step e;
g. Optionally, the mixture resulting from step f. is filtered.

It is important in this method that the active material, i.e. the metallic lithium mixed oxide, does not come into contact with the electrode binder PVDF without prior neutralization, as otherwise undesirable crosslinking reactions could occur. Therefore, the PVDF is dissolved in the solvent containing the organic solvent NMP and/or NEP as well as the organic additive component before the metallic lithium mixed oxide is added. The addition of the lithium mixed oxide to the mixture of the solvent with the PVDF, which may also contain the conductive carbon black, is preferably carried out gradually and/or slowly so that undesirable crosslinking is reliably avoided.

In a step f., the method described optionally permits the setting of a specific viscosity by adding further solvent. The respective viscosity and/or its optional setting in process step f. can be adapted to the respective conditions and applications.

A final filtering of the resulting mixture in step g. of the method, for example with a sieve filter with a mesh size of 50-70 μm, can also be useful depending on the application, or it can be dispensed with if necessary.

The present disclosure further provides a use of the described cathode paste for the production of lithium-ion cells or for the production of corresponding batteries, wherein the cathode paste is applied to a current collector and dried to provide the cathode of the cells.

Finally, the present disclosure provides a method of producing a lithium-ion cell having at least one cathode and at least one anode, or for producing a corresponding battery. In principle, this production process can be carried out in the same way as conventional production processes for lithium-ion cells, in which a cathode paste is used for producing the cathode. A characteristic feature of the production process is that a cathode paste is used for the production or the provision of the at least one cathode, which cathode paste is characterized by the described organic additional component. In the production process, this cathode paste is applied to a current collector and dried. The remaining steps for producing a lithium-ion cell are known to the skilled person.

The current collector for the cathode can be, in particular, a foil or mesh or other layer of aluminum, which has a thickness of between 1 μm and 500 μm, for example. The cathode paste can be applied to this current collector in various ways, wherein a thin layer is preferably applied during the application. The layer thickness can be in the range from 25 μm to 150 μm, for example. A conventional doctor blade process (doctor blade coating) or application with slot nozzles can be used for this purpose. Other coating processes are of course also possible. The layer is then dried, wherein the organic solvent (NMP and/or NEP) and the organic additive component evaporate during this drying step. The resulting cathode layer then adheres firmly to the current collector.

The production of the anode, the arrangement of the separator(s) as well as the introduction of electrolyte and, if necessary, further measures for the production of the lithium-ion cell, for example the contacting of the electrodes, can be carried out in a manner known per se.

In a preferred embodiment of the method, the method is characterized by the following additional feature a.:
a. Drying of the cathode paste after its application to the current collector takes place in a temperature range from 50° C. to 150° C., preferably in a temperature range from 80° C. to 130° C., in particular in a temperature range from 100° C. to 120° C.

During this drying step, the solvent, which consists of the organic solvent NMP and/or NEP and the organic additive component, evaporates. This means that the organic additive component as well as the actual solvent NMP and/or NEP are practically no longer present in the resulting cathode. The addition of the organic additive components therefore does not introduce any additional substances into the cathode which could influence its properties.

Due to the boiling point of the organic additive component in the range from 50° C. to 210° C., the additive component is characterized by the fact that it can evaporate during the drying step provided in a conventional production process of a cathode. Under certain circumstances, the drying conditions, in particular the temperature during the drying process, can be adapted to the organic additive component used in each case in accordance with its respective boiling point. In this context, additive components with a relatively low boiling point are suitable for those processes that operate with relatively low temperatures during drying. If the additive component has a relatively high boiling point, the drying temperature should be selected accordingly.

Due to their boiling point, the preferred organic additives acetoacetic acid ethyl ester and acetic acid or glacial acetic acid are suitable, for example, for conventional production processes in which drying temperatures in the range from 100° C. to 120° C. are used.

In a preferred embodiment of the method, the method is characterized by the following additional feature a.:
a. The formation of the at least one cathode takes place at atmospheric pressure conditions and/or under normal air conditions.

As already explained above, the use of the organic additive component makes it possible to dispense with technically complex measures to avoid undesirable crosslinking reactions of the PVDF, which occur in particular due to the strongly hygroscopic properties of the active material of the cathode, i.e. in particular the lithium mixed oxides with a high nickel content. Thus, when the cathode paste is used in the production process for the lithium-ion cell, no special precautionary measures such as inert gas and/or highly dry atmospheres are required, since crosslinking of the PVDF is prevented by the organic additive component. Therefore, the production or mixing process for the cathode paste and the application process of the cathode paste to a current collector can be carried out at atmospheric pressure conditions and/or under normal air conditions. This makes it possible to design the production process using the cathode paste in a less complex manner, wherein at the same time a consistent quality of the cathode and thus a consistent quality of the resulting lithium-ion cell is ensured.

Further features and advantages result from the following description of examples of embodiments in connection with the drawing. Here, the individual features can each be realized separately or in combination with each other.

Various comparative tests were carried out by the inventors, in which the resulting viscosity properties of the cathode pastes were compared with those of conventional cathode pastes, each after a longer period of time.

The comparative pastes without organic additive component and the cathode pastes were prepared according to the following description.

a) Comparison Cathode Paste (NMC-622) without Organic Additive Component

In a plastic vessel, 142.5 g of N-ethylpyrrolidone (NEP) or N-methylpyrrolidone (NMP) was weighed as solvent. To the solvent, 7.5 g of PVDF powder (Kynar HSV1810; Arkema, France) was added under intensive stirring and stirred until the PVDF powder was completely dissolved.

The solution was mixed with 15 g of conductive carbon black (LiTX200, Cabot, USA) and stirred intensively until a homogeneous mixture (carbon black paste) was obtained.

720 g of NMC-622 cathode active material (purchased from Umicore, Brussels, Belgium) was weighed into a mixing container. To the material, the carbon black paste was added step by step. After each addition step, the resulting mixture was kneaded in a double planetary mixer until the material was homogeneously distributed and an agglomerate-free paste was obtained. To set the specified final viscosity, 40 g of further solvent (NEP or NMP) was added (the same solids content was set in all examples).

The paste was filtered and then tested rheologically and for the presence of agglomerates. For further examination, the paste was stored in a sealed plastic container.

After 28 days of storage at 22° C. and a room humidity of 20-30%, a clear gelation of the paste was observed. The material was solid and no longer homogeneously miscible. Flowability was no longer present.

b) Cathode Paste (NMC-622) with NEP or NMP and Acetoacetic Acid Ethyl Ester

In a plastic vessel, 7.13 g of acetoacetic acid ethyl ester (AEE) and 135.37 g of N-ethylpyrrolidone (NEP) or N-methylpyrrolidone (NMP) were weighed. To the solvent mixture, 7.5 g of PVDF powder (Kynar HSV1810; Arkema, France) was added under intense stirring and stirred until the PVDF powder was completely dissolved.

The solution was mixed with 15 g of conductive carbon black (LiTX200, Cabot, USA) and stirred intensively until a homogeneous mixture (carbon black paste) was obtained.

720 g of NMC-622 cathode active material (purchased from Umicore, Brussels, Belgium) was weighed into a mixing container. To the material, the carbon black paste was added step by step. After each addition step, the resulting mixture was kneaded in a double planetary mixer until the material was homogeneously distributed and an agglomerate-free paste was obtained. To set the specified final viscosity, 40 g of further solvent (AEE and NEP or NMP in a ratio of 1:19) was added (the same solids content was set in all examples).

The paste was filtered and then tested rheologically and for the presence of agglomerates. For further examination, the paste was stored in a sealed plastic container.

After 43 days of storage at 22° C. and a room humidity of 20-30%, no gelation of the paste was observed. The material was slightly sedimented and homogeneously miscible. The flowability was still present.

a) Cathode Paste (NMC-622) with NEP or NMP and Anhydrous Acetic Acid (Glacial Acetic Acid)

In a plastic container, 1.71 g acetic acid (glacial acetic acid) and 140.79 g N-ethylpyrrolidone (NEP) or N-methylpyrrolidone (NMP) were weighed. To the solvent mixture, 7.5 g of PVDF powder (Kynar HSV1810; Arkema, France) was added under intense stirring and stirred until the PVDF powder was completely dissolved.

The solution was mixed with 15 g of conductive carbon black (LiTX200, Cabot, USA) and stirred intensively until a homogeneous mixture (carbon black paste) was obtained.

720 g of NMC-622 cathode active material (purchased from Umicore, Brussels, Belgium) was weighed into a mixing container. To the material, the carbon black paste was added step by step. After each addition step, the resulting mixture was kneaded in a double planetary mixer until the material was homogeneously distributed and an agglomerate-free paste was obtained. Further solvent (glacial acetic acid mixed with NEP or NMP in a ratio of 3:247) was added to set the specified final viscosity (the same solids content was set in all examples).

The paste was filtered and then tested rheologically and for the presence of agglomerates. For further examination, the paste was stored in a sealed plastic container.

After 41 days of storage at 22° C. and a room humidity of 20-30%, no gelation of the paste was observed. The material was somewhat sedimented and homogeneously mixable. The flowability was still present.

a) Comparison Cathode Paste (NMC-811) without Organic Additive Component

The carbon black paste was prepared analogously to example a). 720 g of cathode active material NMC-811 (purchased from Umicore, Brussels, Belgium) was weighed into the mixing container. The material was further processed to a homogeneous paste analogous to example 1 and examined.

After 27 days of storage at 22° C. and a room humidity of 20-30%, gelation of the paste was observed. The material was solid and no longer homogeneously miscible. Flowability was no longer present.

b) Cathode Paste (NMC-811) with NEP or NMP and Acetoacetic Acid Ethyl Ester

The carbon black paste was prepared analogously to example b). 720 g of cathode active material NMC-811 (purchased from Umicore, Brussels, Belgium) was weighed into the mixing container. The material was further processed to a homogeneous paste analogous to example b) and examined.

After 36 days of storage at 22° C. and a room humidity of 20-30%, no gelation of the paste was observed. The material was homogeneously miscible. The flowability was very good.

Overall, these tests showed that the addition of the organic additive component to the solvent of the cathode paste reliably prevented undesirable gelation.

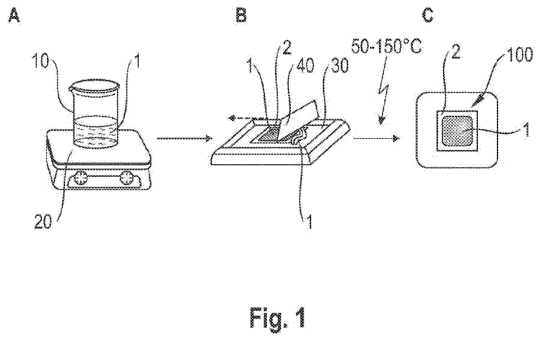

FIG. 1 illustrates an exemplary possibility for further processing of the cathode paste in the production of a lithium-ion cell. The cathode paste is applied to a current collector in a doctor blade process and then dried.

First, the cathode paste 1 is prepared according to the above description, for example according to embodiment b) or c) or e). The cathode paste 1 is provided in a plastic vessel 10 and homogenized with the aid of a stirrer 20 (step A).

To produce the cathode, the cathode paste 1 is applied to a current collector 2, in particular an aluminum foil, as a thin layer. For this purpose, the current collector 2 is placed on a carrier 30 and the cathode paste 1 is applied evenly as a thin layer to the current collector 2 with the aid of a doctor blade 40 (step B).

Subsequently, the cathode paste layer is dried at a temperature in the range from 50° C. to 150° C. Drying in a temperature range of 100° C. to 120° C. is preferred. Depending on the circumstances, drying can be carried out for a period of a few minutes to about an hour, for example between 5 to 60 minutes. During this drying, the solvent evaporates with the organic solvent NMP or NEP and the organic additive component. From this process emerges the completed cathode 100, in which the cathode paste 1 has been applied to the current collector 2 and the solvent has evaporated. This cathode 100 can be further used in a manner known per se for the production of a functional lithium-ion cell.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A cathode paste for producing a cathode of a lithium-ion cell, the cathode paste comprising:
a metallic lithium mixed oxide selected from:
a lithium-nickel-manganese-cobalt mixed oxide of the formula LiNiₓMn_{y}Co_{z}O₂, wherein x+y+z=1 and x≥0.6,
a lithium-nickel-cobalt-aluminum mixed oxide of the formula LiNiₓCo_{y}Al_{z}O₂, wherein x+y+z=1 and x≥0.8, and/or
a mixture comprising the lithium-nickel-manganese-cobalt mixed oxide and/or the lithium-nickel-cobalt-aluminum mixed oxide;
polyvinylidene difluoride as an electrode binder or an electrode binder comprising polyvinylidene difluoride;
a solvent comprising:
N-methylpyrrolidone and/or N-ethylpyrrolidone, and
an organic additive component capable of neutralizing hydroxide ions and having a boiling point at atmospheric pressure in a range from 50° C. to 210° C.

2. The cathode paste of claim 1, wherein the cathode paste is stable with respect to its viscosity properties at room temperature for a period of at least 2 weeks.

3. The cathode paste of claim 1, comprising at least one of the following additional features:
the organic additive component is present in the solvent in a proportion of 0.1 to 10% by weight; and/or
the N-methylpyrrolidone and/or the N-ethylpyrrolidone is present in the solvent in a proportion of from 60 to 99.9% by weight.

4. The cathode paste of claim 1, comprising at least one of the following additional features:
the organic additive component is or comprises an organic acid;
the organic additive component is or comprises a precursor of an organic acid; and/or
the organic additive component is or comprises a C—H-acidic organic compound.

5. The cathode paste of claim 1, comprising at least one of the following additional features:
the organic additive component is Ethyl acetoacetate; and/or
the organic additive component is anhydrous acetic acid.

6. The cathode paste of claim 1, wherein the organic additive component is Ethyl acetoacetate and is present in the solvent in a proportion of 1 to 5% by weight.

7. The cathode paste of claim 1, wherein organic additive component is anhydrous acetic acid and is present in the solvent in a proportion of 1 to 5% by weight.

8. The cathode paste of claim 1, wherein the proportion of solvent in the cathode paste is in the range from 10 to 50% by weight.

9. The cathode paste of claim 1, comprising at least one of the following additional features:
the polyvinylidene difluoride is a polyvinylidene difluoride homopolymer; and/or
the polyvinylidene difluoride comprises ionically crosslinkable components.

10. The cathode paste of claim 1 wherein the cathode paste comprises a conductive agent.

11. A method of producing a cathode paste the method comprising:
providing a solvent that comprises N-methylpyrrolidone and/or N-ethylpyrrolidone and an organic additive component capable of neutralizing hydroxide ions and which has a boiling point at atmospheric pressure in the range from 50° C. to 210° C.:
dissolving an electrode binder based on polyvinylidene difluoride in the solvent with stirring;
selecting a metallic lithium mixed oxide from:
a lithium-nickel-manganese-cobalt mixed oxide of the formula LiNiₓMn_{y}Co_{z}O₂, wherein x+y+z=1 and x≥0.6,
a lithium-nickel-cobalt-aluminum mixed oxide of the formula LiNiₓ Co_{y} Al O_{z2}, wherein x+y+z=1 and x≥0.8, and/or
a mixture comprising the lithium-nickel-manganese-cobalt mixed oxide and/or the lithium-nickel-cobalt-aluminum mixed oxide; and
mixing the metallic lithium mixed oxide with the solvent having the dissolved electrode binder.

12. A method for the production of lithium-ion cells, the method comprising applying the cathode paste to claim 1 to a current collector and drying the cathode paste to provide a cathode of the cells.

13. A method of producing a lithium-ion cell having at least one cathode and at least one anode, the method comprising forming the at least one cathode by applying the cathode paste according to claim 1 to a current collector and drying the cathode past.

14. The method of claim 13, wherein cathode paste is dried in a temperature range from 50° C. to 150° C.

15. The method of claim 13, wherein the forming the at least one cathode takes place at atmospheric pressure conditions and/or under normal air conditions.
